(19) United States
(12) Patent Application Publication
(10) Pub. No.: US 2010/0045711 A1
(43) Pub. Date: Feb. 25, 2010

(54) SYSTEM AND METHOD FOR CONTROL OF THE TRANSPARENCY OF A DISPLAY MEDIUM, PRIMARILY SHOW WINDOWS AND FACADES

(76) Inventors: Kim Halskov, Abyhoj (DK); Morten Constantin Lervig, Arhus (DK)

Correspondence Address: James C Wray, 1493 Chain Bridge Road, McLean, VA, 22101, US

(21) Appl. No.: 12/448,077

(22) PCT Filed: Dec. 7, 2007
(86) PCT No.: PCT/DK2007/000534

§ 371 Date: Jun. 5, 2009

(51) Int. Cl. G09G 5/02; G09G 3/20

(52) U.S. Cl. 345/697; 345/55

(57) ABSTRACT

A power transmission cable includes at least one power conductor, an insulating layer surrounding the conductor to form at least one insulated conductor, a flame-retardant halogen free protective sheath provided in a radially external position with respect to the insulated conductor, wherein the sheath has an inner and an outer layer in contact with each other, the inner layer having a thickness at least equal to a thickness of the outer layer, the inner layer including a polymer material having a glass transition temperature equal to or lower than −30° C., and the outer layer including a mud resistant polymer material.

### FIELD OF THE INVENTION

The present invention concerns a system and a method for controlling the transparency of a display medium, e.g. show windows and facades, and which is divided into a plurality of fields that may switch between a clearly transparent condition and a not clearly transparent condition.

### BACKGROUND OF THE INVENTION

A number of systems for visual imaging exist where the image depends on the presence of persons or objects. U.S. Pat. No. 6,616,284 describes a method and a system for projecting an image onto a display medium, for example a window or a screen, where a sensor is used to detect if there is an observer in front of the display medium concerned. On the basis of detecting an observer, one or more of the parts of the display medium are changed from being transparent to be mat or frosted. At the time where the display medium becomes mat or frosted, an image is projected on the display medium.

U.S. Pat. No. 5,589,958 disclose a kitchen where the cabinet fronts and/or fronts on appliances, such as for example a freezer or a refrigerator, are made from a material where the opacity (transparency) may by controlled by one front at a time or all fronts simultaneously. By being able to control each front separately also a billboard construction is illustrated where a surface comprising a number of fields acting as fronts may be controlled in order to convey a billboard message. In order to achieve the effect the fronts are provided with a PDLC film.

U.S. Pat. No. 5,123,192 discloses a show window including a display (LCD) the transparency of which is changed on the basis of detections from a sensor. The presence of a passer-by will generate a signal causing the display to be transparent, so that the passer-by can see an article in the window, e.g. displayed clothes or shoes.

U.S. Pat. No. 6,588,909 concerns a projection system with a shop window that may switch between a transparent condition and a matt condition in sections for projecting images on the unclear part. In addition, a mirror is provided behind the screen in order to mix the viewer's reflection with the projected image.

Moreover, from US 2003/0011754 it is known to use a sensor for detecting a person in the proximity of a projection screen. When the person is detected, some fields of or the entire screen may change their character, e.g. from opaque to transparent, or vice versa, after which an image, film or similar may be projected on the opaque part of the screen. The system thus reacts to a person activating a sensor. More sensors may be activated by different sensors, but in each case a field associated with the sensor is controlled.

Yet a system is known from US 2004/036717, in which the projection is changed in relation to the one viewing the projected image. The position and/or movement of the persons is detected by means of sensors, which is used as input for projector control which then, with knowledge of the surroundings, projects the image or the information as suitably as possible so that the person does not “stand in the way” of the projection.

Even though these systems may be used widely for attracting the attention of the passer-by, there is still a need for improvements in this area. In particular, the above systems are not so suitable if the person moves quickly past a shop window, as the time available for attracting the attention is short.

A thin film, Magic Foil®, is commercially available, the transparency of which depending on the electric potential difference between the outer sides of the film. It is possible to use Magic Foil® for instantly changing the display on a front window. It is thus possible to interchange between a mat grey front and another subject lying behind it.

### DESCRIPTION OF THE INVENTION

The present invention has the purpose of providing a system and a method which are further developments of the above systems and which attract the attention of the passer-by more, even if the person is moving quickly.

This purpose is achieved according to the present invention by a method for changing the transparency of a display medium which is divided into a plurality of fields, where the fields are configured for controlled switching between a clearly transparent condition and a not clearly transparent condition. By the method, at least one section with several fields of the display medium is selected for switching between a not clearly transparent and clearly, transparent condition, and the switching of the fields is controlled successively so that the transparent section travels across the display medium in a dynamical way.

Typically, the display medium includes a shop window with a viewer in front of the shop window and display objects behind the shop window. A viewer may thus see objects behind the sections of the shop window that are clearly transparent, while the rest of the window is not clearly transparent, e.g. frosted or mat. Such a frosted surface may, on the other hand, be used for displaying pictures and/or film sequences which are projected on the frosted surface, for example from the back side of the show window. By the invention there are achieved systems that are more dynamic, as the position of the transparent section depends on the movement of the viewer, thereby being provided with more degrees of freedom than systems according to prior art.

The above described systems of prior art are developed for statically displaying a message and/or for providing that the message is not shaded by the viewer. Besides, there is also provided possibility of interchanging between transparent and opaque conditions.

Even if the invention is preferred applied in connection with show windows, the invention is not, however, limited to this purpose, as there may also be used other types of glass panes or other types of screens, e.g. screens that constitute walls. Also, it is not a requirement that the display medium includes a plane surface as curving surfaces may also be used in connection with the invention.

An embodiment of the invention which is efficient in connection with attracting attention is provided by a method where the switching between not clearly transparent and clearly transparent condition of the fields provides the apparently random movement of the clearly transparent section across the display medium. Such a random movement of an apparent window is known from screensavers of computers. This similarity will typically produce association to the home computer on the part of the passers-by and attract attention, as this function known from other side now appears in quite another connection.

The fields may be rectangular, constitute polygons or have other geometric shapes. They may be various parallel paths or an arbitrary combination of these mentioned variations.

In that connection it is to be mentioned that the invention will typically find application in connection with the presence of person in front of the medium, but there may also be possibility of the presence of another type of object, e.g. a car or a bus driving past a window.

In another embodiment, detection means, for example in the form of cameras and/or other types of movement sensors, are provided and configured for detecting persons or objects in the vicinity of and in front of the display medium, where the method includes selecting one or more stationary or dynamical areas behind the display medium, e.g. a particularly interesting object, and selecting the fields on the display medium for switching between a not clearly transparent and clearly transparent condition which, depending on the person's position, allows the person to see the selected area or areas. For example, a control unit may be programmed for measuring a person's position relative to a certain article behind a show window and then calculate the fields that are to be transparent in order that the person can see the article, and only this article, irrespectively of the position in front of the window.

Alternatively, the transparency of certain fields may be changed successively on display medium so that there is attained dynamic change of the position of the transparent section or sections on the display medium, where the position follows persons or objects passing by. For example, the person passing by a show window may only look through the show window at a certain angle, e.g. only see through the window at an angle which is largely perpendicular to the show window.

In a further embodiment, the control means selects a set of fields that together constitute a first section with a first size or extent, and where this set of fields is made transparent within this extent, where the extent e.g. may correspond to the outline of the person or the object in front of the display medium, and where this set of fields is changed successively while maintaining the extent travelling across the display medium concurrently with the movement of the person or object along the display medium. The size or extent of the section may then be either static and keep its shape, or be dynamic and imitate the person's changing outline during the movement.

In a further preferred embodiment, one or more fields in a section or one or more sections in the display medium are used for projection, where the other and/or intermediate fields or sections are shaded by means of a computer generated mask in a projector. This is to be considered in connection with the computer based control of both projector and display medium, enabling a raster for a part of the projector chip to be produced statically or dynamically via the computer. Typically, projectors of the LCD type will have a chip that determines/forms the image to be projected. By putting on a raster (diaphragm), no light is emitted in the field, whereby the projection in the field in question becomes dark.

In yet a preferred embodiment, fields and/or sections and/or projection is selected interactively by a person. This enables a person in front of the display medium to be able to actively select or play with the projected information or image, or alternatively to create an interplay between opaque and transparent fields, whereby the person is involved in the operation/control of the display medium.

The purpose of the invention is also fulfilled by a display system including a display medium divided into a plurality of fields that are configured for switching between a clearly transparent condition and a not clearly transparent condition, and a control means functionally connected to the fields of the display medium and configured for selecting at least one section of the display medium for switching between hot clearly transparent and clearly transparent condition. The control means is then configured for controlling the switching of the fields successively so that the transparent section travels across the display medium in a dynamical way.

Furthermore, the display system may include detection means, for example cameras and/or other types of sensors, for detecting persons or objects in front of the display medium and configured for detecting persons or other type of object in the vicinity of the display medium, where the control means is also functionally coupled to the detection means and, depending on the detecting of the detection means, configured to control the transparency of the fields of the display medium. In a concrete embodiment, the control means is programmed for successively selecting certain fields for switching between not clearly transparent and clearly transparent condition as a reaction to detecting changes of position of persons and/or objects in order to change the transparency of the fields in a dynamical way for following the movement of the person and/or object in the display medium

Additionally, the detection means may be adapted for measuring the distance between the position of the display medium and the position of persons and/or objects. Such detection means are e.g. movement sensors. Alternatively, the detection means may include one or more cameras. The control means may e.g. be adapted to combine the signals from the cameras for calculating the distance between the person or the object and the display medium. As a further alternative, a sensor for detecting one or more persons or object may be disposed in each of the fields, for example at the corner of the field.

The cameras and the control system may furthermore be used for detecting the body movements of a person as so-called gestures for controlling the position and shape of the clear section. The system may e.g. be programmed for reading a movement of a hand to the right as a gesture for displacing a clearly transparent section. Alternatively, a pushing movement of a person may be apprehended as a gesture for, so to say, pushing the clear window. In that way persons may be activated and increased attention may be attracted. The clear section then becomes an interactive window to the world at the opposite side of e.g. a show window.

By a system and a method according to the invention is thus achieved a number of advantages, as a dynamic and successive change of the individual parts of the display media is established in dependence of position and/or speed and/or acceleration of persons or objects. Hereby it becomes possible to provide dynamic display media where the activity of passers-by results in activation of a number of fields. Thus it becomes possible to provide display media where the presence of several humans results in more sections becoming visible or changing their character. It will also be feasible to provide a display system with display media which include so many fields that visible images with high resolution, e.g. corresponding to a number of fields changing their character in connection with hand movements or arm movements. Thus it becomes possible to project an image on parts of the window fields corresponding to the activity of passers-by.

By using a film the transparency of which depends on the electric potential difference between the outer sides of the film, there is achieved possibility of changing the transparency of the film and hereby the visible image. It is thus possible to use a surface that changes between being frosted or coloured and transparent by changing electric potential difference between the outer sides of the film. It is furthermore advantageous to use a film the transparency of which depends on the potential difference between the outer sides of the coating, because an electric control of the transparency of the film may hereby be provided by using control means that connect electric different fields covered with film. Such control means may e.g. include a computer.

The detecting means may include one or more sensors, not only for detecting position but also speed and/or acceleration, of persons and/or objects. Hereby it becomes possible to use position as well as movement related parameters for determining the character and nature of the visible images and determining the transparent fields. It is thus possible to adapt the visible images for the character and nature of specific movements for adapting the visible images. A passer-by who stops and looks at a display medium may thus experience a visualisation that not only reflects the position of the person, but also the person's moving speed and the rate at which this is changed. For example, between the person's movements and the response there may be provided some kind of hysteresis, so that the changes of the transparent part is slightly late or slow in relation to the movements of the person. Furthermore, the transparent part may behave like a soft, changeable outline changing in dependence of the speed at which a person or object is moving. For example, a sudden stop of the movement of a person or object may cause an approximated lapping movement back and forth of the transparent section, until this section comes to rest after some time, e.g. some seconds.

Furthermore, the display medium may include means for emitting light and/or playing sound signals in addition to the visible image. Such an embodiment will be advantageous because it contains a larger number of possibilities for providing displays, e.g. in connection with show windows or other forms of display situations. The use of sound and light signals may e.g. be a suitable supplement for projecting an image on a show window.

By the system according to the invention there may thus be the possibility of providing a “reflection” effect where e.g. a viewer in front of a window sees an image with an extent that highly corresponds to the extent of the person's own reflection. This effect will be of interest since it will involve the viewer as a part of the image. It will thus be easier to catch the attention of the viewer because the viewer indirectly becomes a part of the image.

As mentioned above, one or more cameras for detecting signals corresponding to the activity in front of one or more display media, e.g. shop windows, may be used, where the signals are applied to parts of the fields of the display media. Other types of movement sensors or combinations of such sensors with cameras may also be used. Hereby is achieved the possibility of involving viewers in specific visualisations. This may attract the viewer's attention because the viewer becomes part of the image, which in addition may be designed as a play where the viewer is to move in relation to a transparent section, or where the viewer may control the transparent section.

It may be video signals containing visible light or e.g. infrared light. By incorporating infrared light, the system may operate without presence of visible light, e.g. at night.

It is possible to use a projected image on e.g. a shop window, a show window or a window section in an office building where the image is used as “screen saver” and where the movements of passers-by cause changes in the “screen saver”.

### DESCRIPTION OF THE DRAWING

In the following, the invention may be explained with reference to the accompanying drawing, wherein:

FIG. 1 shows a view of a person in front of a window; and

FIG. 2 shows a schematic view of a show window.

### DETAILED DESCRIPTION OF THE INVENTION

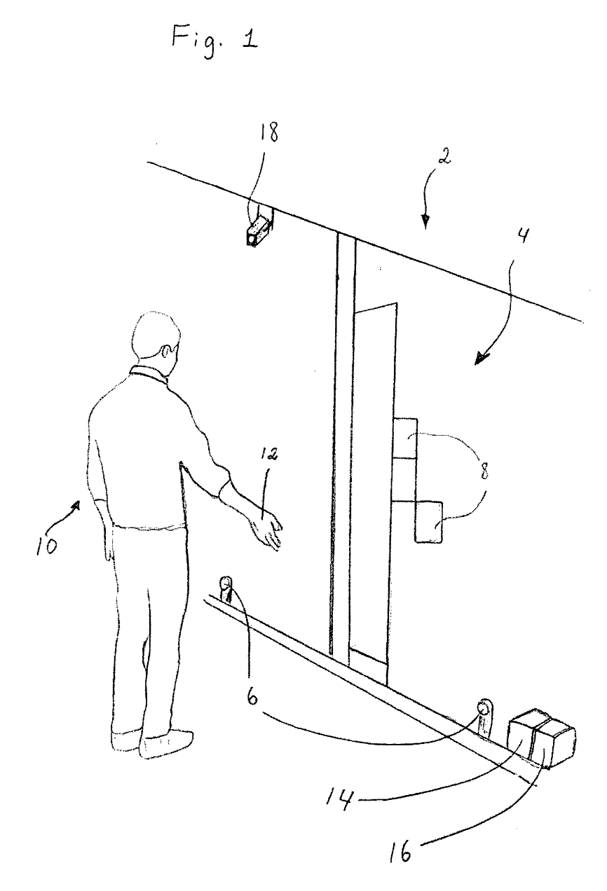

FIG. 1 shows a display system 2, including a show window 4 consisting of a glass pane with a number of fields 8 covered by a coating. The display system 2 includes two further sensors 6, a computer 16, a camera 18 and a control unit 14. In front of the show window 4, a person 10 is standing and moving his right hand 12.

The sensors 6 continuously pick up the 10 position of the person, including the position of individual body segments. The position of the hand 12 is thus also determined. The computer 16 receives the detected positions and calculates the speed and acceleration of the body segments on the basis of the position detections. The registered positions and the calculated speeds and accelerations are subsequently used as input in an algorithm, the output of which applying certain characteristics, to the fields 8 on the show window by means of the control unit 14. It is possible to make certain fields 8 transparent by applying a potential difference between the outer sides of actual fields 8. FIG. 1 shows how the movements of the hand 12 in downward direction result in change of certain fields 8.

It is possible to use various kinds of sensors 6. There may e.g. be used ultrasound sensors or sensors detecting infrared radiation (heat). It is also possible to use a combination of several detection technologies.

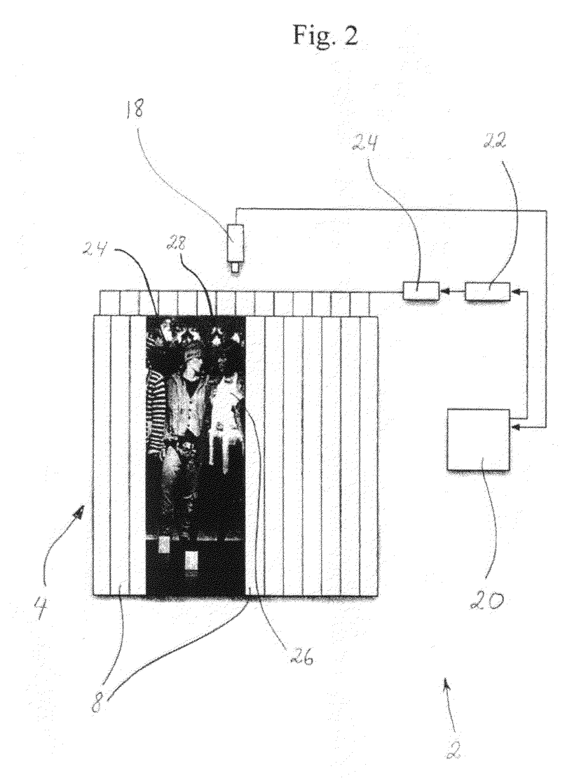

FIG. 2 shows schematically a display system 2 including a show window 4 consisting of a number of vertically extending rectangular fields 8 with frosted or mat coating. The show window 4 further includes an area 28 where the fields are transparent due to electric activation of the coating. In this area, two dummies 24, 26 are seen through clearly transparent section. The display system 2 furthermore includes a converter 22, a relay 24, a camera 18 and a computer 20. The camera 18 is connected to the computer 20 which is further connected to the converter 22 and the relay 24.

During use, the camera 18 transmits a video signal corresponding to the activity in front of the show window 4 to the computer 20, In the computer 20 it is calculated where a change in the image has occurred in front of the show window 4, and the identity of the corresponding fields 8 on the show window 4 is transmitted via a data connection, e.g. through a USB port, to the converter 22, which converts the signal to an electric signal which in the relay 24 is converted into electric currents that are applied to the fields 8. The fields 8 contain a frosted coating consisting of film which can be made transparent by applying a potential difference between the outer sides of the film. Detection of changes in front of the show window 4 can be effected by means of a video camera 18, but it is also possible to use other kinds of sensors, e.g. ultrasound sensors or sensor detecting infrared radiation, or combinations of these types of detectors.

1. A method for changing the transparency of a display medium divided into a plurality of fields (8), which are configured for controlled switching between a clearly transparent condition and a not clearly transparent condition, wherein the method includes selecting at least one section with several fields of the display medium (4) for switching between a not clearly transparent and clearly transparent condition, and for controlling the switching of the fields successively so that the transparent section travels across the display medium in a dynamical way.

2. Method according to claim 1, wherein the display medium (4) includes a show window.

3. Method according to claim 1, wherein the switching between not clearly transparent and clearly transparent condition of the fields (8) provides the apparently random movement of the clearly transparent section across the display medium.

4. Method according to claim 1, wherein detection means (6) are provided and configured for detecting persons (10) or objects (12) in the vicinity of and in front of the display medium, where the method includes selecting one or more stationary or dynamical areas behind the display medium (4) and selecting the fields (8) on the display medium (4) for switching between a not clearly transparent and clearly transparent condition which, depending on the person's position, allows the person to see the selected area or areas.

5. Method according to claim 4, wherein the transparency of certain fields is changed successively on the display medium (4) so that there is achieved a dynamic switching of the position for the transparent section or sections on the display medium (4), where the position follows persons or objects passing by.

6. Method according to claim 4, wherein the control means (14) selects a set of fields that together constitute a first section with a first size or extent, and where this set of fields is made transparent in this section, and where this set of fields is changed successively while maintaining or roughly maintaining the size travelling across the display medium concurrently with the movement of the person (10) or object (12) along the display medium.

7. Method according to claim 6, wherein the extent corresponds to the outline of the person (10) or the object (12) in front of the display medium (4).

8. Method according to claim 1, wherein one or more fields in a section or one or more sections in the display medium are used for projection, where the other and/or intermediate fields or sections are shaded by means of a computer generated mask in a projector.

9. Method according to claim 4, wherein selection of fields and/sections and/or projection is made interactively by a person.

10. A display system (2) including
a display medium (4) divided into a plurality of fields (8), where each field has means for switching between a clearly transparent condition and a not clearly transparent condition;
wherein
a control means connected to the fields (8) of the display medium and where said control means comprises means for selecting and switching at least one section, where said section comprises several fields of the display medium (4) between a not clearly transparent and a clearly transparent condition;
the control means has means for dynamically controlling the switching of the fields successively so that the transparent section travels across the display medium in a dynamical way.

11. Display system according to claim 10, wherein the system includes detection means (6) configured for detecting persons (10) or other types of objects (12) in the vicinity of the display medium, where the control means (14) is also functionally coupled to the detection means (6) and, depending on the detecting of the detection means, configured to control the transparency of the fields (8) of the display medium (4),
wherein the control means (14) is programmed for successively selecting certain fields (8) for switching between not clearly transparent and clearly transparent condition as a reaction to detecting changes of position of persons (10) and/or objects (12) in order to change the transparency of the fields in a dynamical way for following the movement of the person and/or object in the display medium (4).

12. Display system (2) according to claim 10, where the detection means (6) includes one or more cameras (6) for detecting the body movements of a person, and where the control system is programmed for detecting body movements as gestures for controlling the position and shape of the clear section.
